(19) United States
(12) Patent Application Publication
(10) Pub. No.: US 2025/0048107 A1
(43) Pub. Date: Feb. 6, 2025

(54) SECURED RADIO FREQUENCY IDENTIFICATION DEVICES

(71) Applicant: INTERNATIONAL BUSINESS MACHINES CORPORATION, ARMONK, NY (US)

(72) Inventors: Guang Han Sui, Beijing (CN); Peng Hui Jiang, Beijing (CN); Su Liu, Austin, TX (US); Jun Su, Beijing (CN)

(21) Appl. No.: 18/364,681

(22) Filed: Aug. 3, 2023

(51) Int. Cl. H04W 12/47; G06F 21/60; G06Q 10/0833; H04W 12/63

(52) U.S. Cl. CPC H04W 12/47; G06F 21/602; G06Q 10/0833; H04W 12/63

(57) ABSTRACT

According to an example of the present subject matter, a secured radio frequency identification device includes: a first radio frequency identification (RFID) tag; and a secured radio frequency identification (RFID) tag having a transmission control for selectively enabling and disabling data transmission from the secured RFID tag. The first RFID tag is to store non-sensitive data from a data set and the secured RFID tag is to store sensitive data from the same data set such that all the data of the data set is only accessible when the secured RFID tag is enabled for data transmission.

### BACKGROUND

Radio Frequency Identification (RFID) tags have emerged as a significant technological advancement in the field of identification and tracking systems. These small electronic devices have found extensive applications in a wide range of industries. RFID tags provide a unique identification number for objects or entities and enable wireless communication through the utilization of radio waves.

RFID tags consist of several components, including a microchip and an antenna. The microchip stores and processes the unique identification number and additional data associated with the tag. Meanwhile, the antenna facilitates the reception and transmission of radio frequency signals. These components are typically embedded within a substrate, which provides structural support and protection to ensure the tag's durability.

The operation of RFID tags is based on radio wave technology. When an RFID reader emits radio frequency signals, it activates nearby RFID tags within its range. Unlike conventional barcode scanners, RFID tags do not require direct line-of-sight contact with the reader. Instead, they respond to the reader's signal by utilizing the power supplied by the reader itself. This power activates the microchip within the tag, enabling it to transmit its stored data back to the reader via the antenna. The reader captures this response and interprets the transmitted information.

However, the use of RFID tags can pose security issues. In most implementations, any reader can activate and receive the information stored on an RFID tag. Consequently, that information of the RFID tag may be read by an unauthorized party.

### SUMMARY

According to an example of the present subject matter, a secured radio frequency identification device includes: a first radio frequency identification (RFID) tag; and a secured radio frequency identification (RFID) tag having a transmission control for selectively enabling and disabling data transmission from the secured RFID tag. The first RFID tag is to store non-sensitive data from a data set and the secured RFID tag is to store sensitive data from the same data set such that all the data of the data set is only accessible when the secured RFID tag is enabled for data transmission.

In another example, a method of securing a data set in a radio frequency identification (RFID) device includes the following. The RFID device has at least one regular RFID tag and at least one secured RFID tag, each secured RFID tag comprising a transmission control for selectively enabling and disabling data transmission from that secured RFID tag. The method includes: parsing a data set to divide the data set into sensitive and non-sensitive information; writing the sensitive information of the data set to a secured RFID tag; and writing the non-sensitive information of the data set to a regular RFID tag. The data set can be entirely accessed from the RFID device only when the transmission control has enabled data transmission in the secured RFID tag.

In still another example, a computer programming product comprising a non-transitory machine-readable medium storing instructions for a radio frequency identification reader system, the instructions, when executed by a processor of the reader system, causing the reader system to: read sensitive information from a secured RFID tag when the RFID tag is enabled for data transmission, the secured RFID tag comprising a transmission control for selectively enabling and disabling data transmission from the secured RFID tag; read non-sensitive information from a separate, regular RFID tag; and use the sensitive and non-sensitive information to obtain a data set to which both the sensitive and non-sensitive information correspond.

### BRIEF DESCRIPTION OF THE DRAWINGS

FIG. 1 depicts an example of a radio frequency identification (RFID) device according to principles described herein in one possible application, i.e., cargo tracking.

FIG. 2 depicts additional details of the RFID device according to an example of the principles described herein.

FIG. 3 depicts an example technique of using the RFID device according to an example of the principles described herein.

FIG. 4 depicts another example technique of using the RFID device according to an example of the principles described herein.

FIG. 5 depicts another example application of the RFID device according to an example of the principles described herein.

FIG. 6 depicts another example technique of using the RFID device according to an example of the principles described herein.

FIG. 7 depicts a flow-chart of techniques of using the RFID device according to an example of the principles described herein.

FIG. 8 depicts a computer program product for operating the RFID device according to an example of the principles described herein.

FIG. 9 depicts a computing environment for the execution of a computer-implemented method or application, according to an example of the principles described herein.

### DETAILED DESCRIPTION

As noted above, RFID tags consist of several components, including a microchip and an antenna. The microchip stores a unique identification number and possibly additional data associated with the tag. Some RFID tags are writeable and can update the stored data, including receiving and processing new data. The antenna facilitates the reception and transmission of radio frequency signals. Thus, the antenna receives a radio frequency read signal from a read and transmits data stored on the RFID tag in response. Specifically, when an RFID reader emits radio frequency signals, it activates nearby RFID tags within its range. In common implementations, the RFID tag does not include a power source but rather utilizes power supplied by the reader signal received from the reader to transmit a response. The reader captures the response and interprets the transmitted information.

RFID tags are available in different types to suit various applications. Active tags incorporate their own power source, typically in the form of a battery, which allows them to transmit signals over longer distances. Passive tags, in contrast, do not possess a separate power source and rely solely on the energy provided by the reader for their operation. While passive tags have shorter read ranges, they are commonly employed in applications such as inventory management, access control, and supply chain tracking.

However, the use of RFID tags can pose security issues. In most implementations, any reader can activate and receive the information stored on an RFID tag. Consequently, that information of the RFID tag may be read by an unauthorized party. Where that information may be sensitive, it would be preferred that only an authorized party is able to access and read the information. Thus, a technical solution is needed to solve this technical data security problem.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse or any given order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used in the present specification and in the appended claims, the term “a number of” or similar language is meant to be understood broadly as any positive number including 1 to infinity.

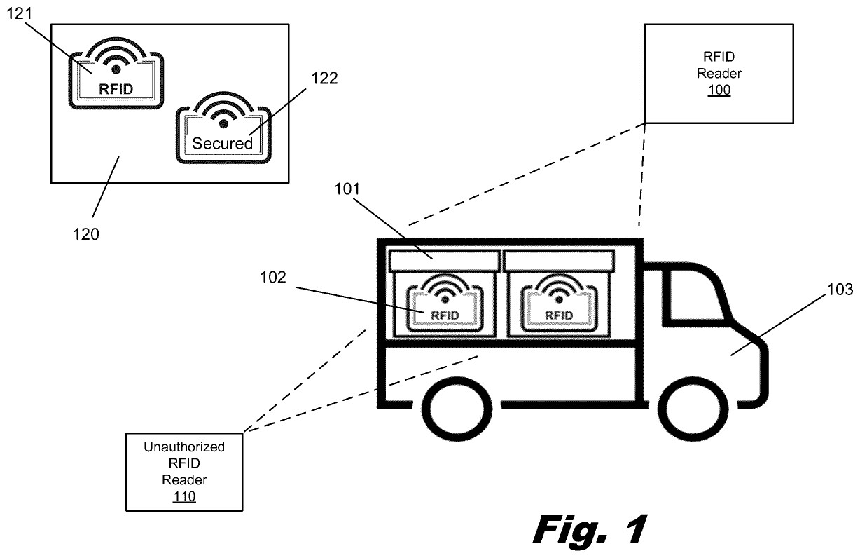

FIG. 1 illustrates the issue and solution in the context of a common application of RFID tags. As shown in FIG. 1, RFID tags 102 are commonly attached to different units of cargo 101 that are being transported, for example, by a truck or any transport vehicle 103. While this specific example is shown for illustration, the principles described herein are applicable to any use of RFID tags. As noted above, this includes a wide variety of different fields and uses from inventory and logistics to health care, security and others.

In the example of FIG. 1, each RFID tag 102 may store information about the unit of cargo to which it is affixed. For example, the RFID tag 102 may store a unique serial or identification number for the unit, a description of the cargo, a quantity of the cargo, ownership or delivery information and/or other details. This is very useful in tracking and managing the cargo 101. Specifically, an RFID reader 100 can emit a radio frequency read signal and obtain the information stored on all the RFID tags 101 on the transport vehicle 103. An operator can then verify that the correct cargo is loaded on the transport vehicle 103, that the transport is bound for the correct destination or any other such details to promote effective logistics.

However, as also shown in FIG. 1, there are security concerns. Specifically, an unauthorized RFID reader 110 can also, when in the appropriate proximity, read the RFID tags 102 of the shipment. Thus, an unauthorized party may gain access to all the information about the cargo 101 stored in the RFID tags 102.

To provide security for RFID tags, various measures have been explored. For example, a conductive material or envelope can be placed around the RFID tag. This scatters any radio frequency read signal and prevents reading of the RFID tag until the tag is removed from the protective envelope. In the context of a credit card, for example, an RFID-blocking wallet can be used to store the cards so that the RFID component cannot be read until the card is removed from the wallet. While effective, this solution is, however, less practical in the scenario of FIG. 1 where there are a large number of RFID tags dispersed throughout a load of cargo. In such a case, removing a protective envelope from each tag 102 prior to reading the data may be unduly burdensome and time consuming.

Near Field Communication (NFC) is a subset of RFID technology that operates over a relatively shorter range. This protects the data on the RFID tags because an unauthorized reader must be placed closer to the tags before any data can be retrieved. However, in the scenario of FIG. 1, this again is less practical where there is significant advantage is reading RFID tags spread throughout a larger space.

Another possible security measure is to encrypt the data stored in the RFID tag 102. In this example, the unauthorized reader 110 will receive the encrypted data and be unable to decrypt the information. However, this approach necessitates transferring the encryption key securely to the authorized RFID reading system 100. Such a system may be complex, error prone or have other vulnerabilities.

To address these issues while providing security for the data of an RFID tag, the present description presents a composite device 120 that includes a traditional RFID component 121 and a secured RFID component 122. The secured RFID component 122 is defined by including a mechanism that permits only selective transmission of the data stored on the secured RFID component 122. As will be described below, this allows the two components 121, 122 to work together to provide the data of the device 120 in a secure manner to an authorized reader only. The device 120 can be constituted by two separate RFID tags, one secured 122 and one unsecured 121. Alternatively, the device 120 can be an integration of the two components 121, 122 in a single tag or package. In some examples, at least the secure RFID component 122 is writeable so that the data stored can be updated, replaced or changed.

As noted above, the secured RFID component 122 is characterized by a mechanism the enables/disables the data transmission capability or function of the component 122. As noted above, an RFID tag can be enabled/disabled by removing it from, or placing it in, a conductive shield. Similarly, attaching or detaching the antenna of the RFID tag will enable or disable the data transmission capability.

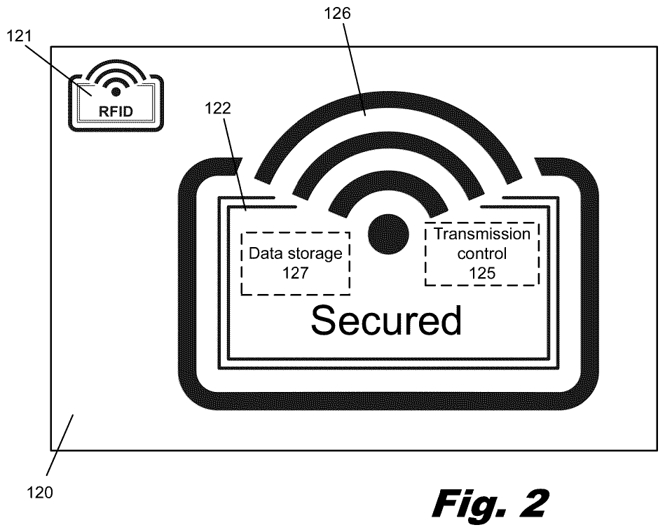

However, as shown in FIG. 2, the secured RFID component 122 includes a transmission control device 125. This transmission control device 125 controls whether the secured RFID component 122 can be read. For example, the transmission control device 125 may include a switch that makes or interrupts the connection between the antenna 126 and the data storage unit 127 of the secured RFID component 122.

In other examples, the transmission control device 125 may be a location aware circuit. This location aware circuit may operate using Global Positioning System (GPS) signals or may have other means to detect its location. For example, the location aware circuit may detect a specific radio frequency signal that is broadcast by a system operator only within a particular location, such as a warehouse or other specific facility. The location aware circuit may use ambient mobile network signals to determine its location. Any technique for electronically identifying one location from another can be used by the location aware circuit.

In such examples, the transmission control device 125 with the location aware circuit is programmed or configured to only permit transmission of data from the data storage unit 127 when the transmission control device 125 determined itself to be in an appropriate location. For example, if the transmission control device 125 determines that it is within a specific location or facility, using any of the techniques described above or others, transmission is enabled and the data in the storage 127 is readable. Otherwise, the transmission control device 125 disables the secured RFID component 122 which will then not respond to a reader by transmitting data from the storage 127.

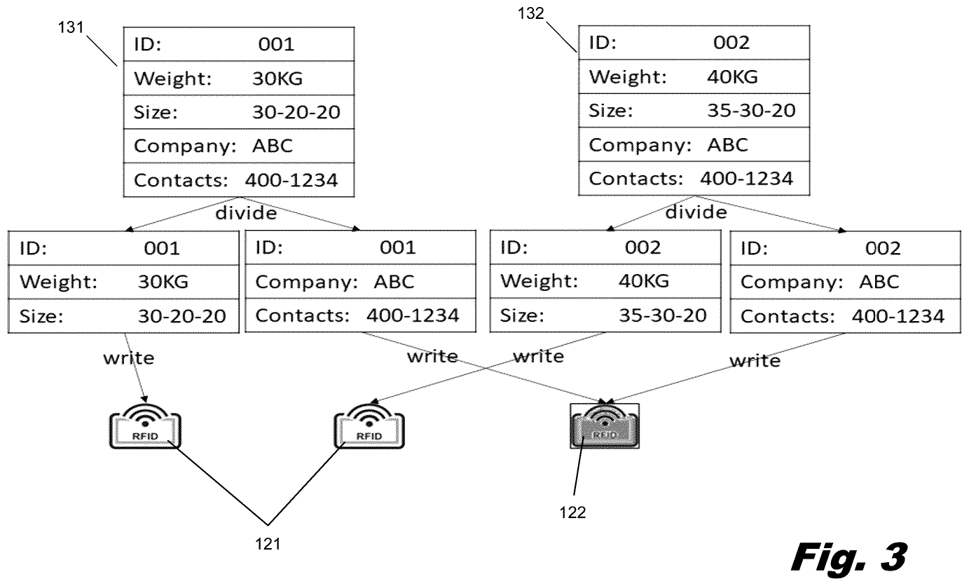

FIG. 3 illustrates an example technique for using secured and unsecured RFID components in tandem to prevent the unauthorized access of data stored in the RFID system. As shown in FIG. 3, the technique involves dividing a data set, with some of the data stored in a regular RFID unit 121 and some of the data stored in a secured RFID unit 122. In this way, the complete data set can only be obtained by reading the data in both the regular and secured RFID units. This can only then be done when the secured RFID 122 is activated and in the mode to transmit data, for example, based on location or other condition as described above.

In the example of FIG. 3, there are two data sets 131, 132. Each data set might be associated with a unit of cargo being shipped. In the illustrated example, each data set includes fields for an identification number (ID), a weight value, a size value, a company name and a contacts value. In this example, the company name and contacts may be considered sensitive information to be protected. Consequently, the ID, weight and size from each record is written to a regular RFID tag 121 associated with a respective unit of cargo. The sensitive information, i.e., the company name and contacts in association with the ID number, is written to the secured RFID tag 122.

As illustrated in FIG. 3, each unit of cargo that needs to be identified and tracked may have its own regular RFID tag affixed with that RFID tag containing the non-sensitive information for that unit of cargo. In some examples, each such regular RFID tag may be paired with a corresponding secured RFID tag, as described herein to store the confidential or sensitive information for that unit of cargo. However, as illustrated in FIG. 3, it is not necessary to pair each regular RFID tag with a secured RFID tag. Rather, a single secured RFID tag 122 can store all the sensitive data for multiple data sets. In the example of FIG. 3, the sensitive data elements from both data sets 131, 132 are stored in one secured RFID tag 122. Thus, a reader would be programmed or configured to read the data from the regular RFID tags 121 and the secured RFID tag 122. The two complete data sets 131, 132 can then be assembled, using the ID, to match the non-sensitive data from one of the regular RFID tags 121 with corresponding sensitive data from the secured RFID 122.

In this way, only under appropriate conditions is the secured RFID tag 122 enabled to transmit its data. This can be, for example, by operating a switch or other mechanism on the secured RFID tag or because the secured RFID tag determines that it is in a particular location. Thus, under the appropriate condition, the reader is able to retrieve the non-sensitive data from the regular RFID tags 121 and the sensitive data from the secured RFID tag 122.

In one such example, when a load of cargo is ready to leave or is arriving at a secured facility, the secured RFID tag 122 is enabled to transmit. A reader can then retrieve all sensitive and non-sensitive data to reassemble the data sets 131, 132. However, when the load of cargo is not in a secured facility, such as during transport, the secured RFID tag 122 is not enabled to transmit by operation of the transmission control (125, FIG. 2). Thus, an unauthorized reader is unable to obtain any of the sensitive data from the secured RFID tag 122 and cannot gain access to the complete data sets 131, 132.

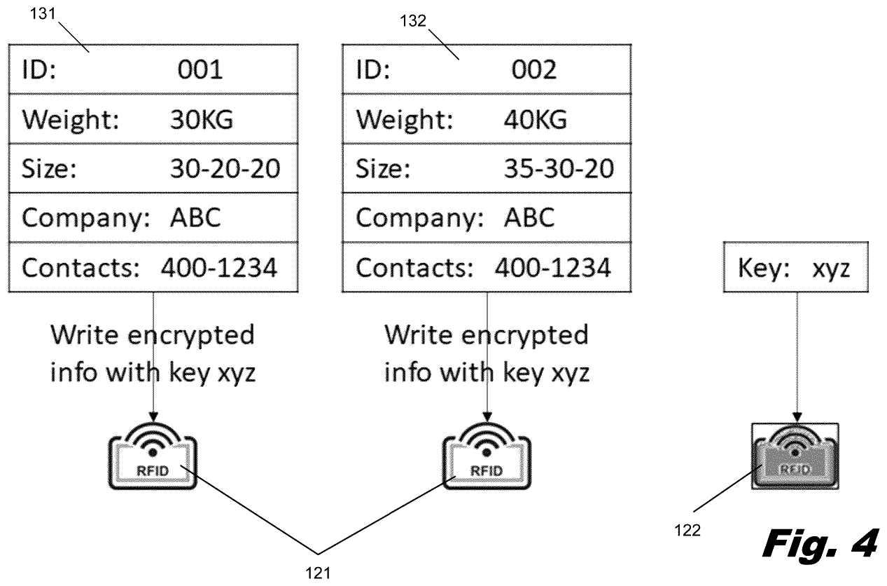

FIG. 4 illustrates another possible application of the principles described herein. Similar to FIG. 3, FIG. 4 shows the same two data sets 131, 132. However, each data set is encrypted using an encryption key (xyz). The encrypted data is then stored in a respective regular RFID tag 121. Again, in the illustrated embodiment, each data set may be associated with a unit of cargo and stored, in encrypted form, in the RFID tag 121 affixed to that unit of cargo. The encryption key (xyz) is then stored in a secured RFID tag 122 that is disposed with the cargo load including the RFID tags 121.

In this way, a reader is able to retrieve the data sets 131, 132 by reading the regular RFID tags 121 for the encrypted data and the secured RFID tag 122 for the encryption key. The reader can then use the encryption key to decrypt the data sets. There is no need for an additional secure system to provide the encryption key to the reader. Rather, under appropriate conditions, the secured RFID tag 122 is enabled to transmit its data. As noted above, this could be, for example, by operating a switch or other mechanism on the secured RFID tag or because the secured RFID tag determines that it is in a particular location. Thus, under the right conditions, the reader is able to retrieve the encrypted data and the encryption key to decrypt the data.

In one such example, when a load of cargo is ready to leave or is arriving at a secured facility, the secured RFID tag 122 is enabled to transmit. A reader then retrieves all the encrypted data and the encryption key to decrypt the data. However, when the load of cargo is not in a secured facility, such as during transport, the secured RFID tag 122 is not enabled to transmit by operation of the transmission control (125, FIG. 2). Thus, an unauthorized reader is unable to obtain anything but encrypted data from the regular RFID tags 121.

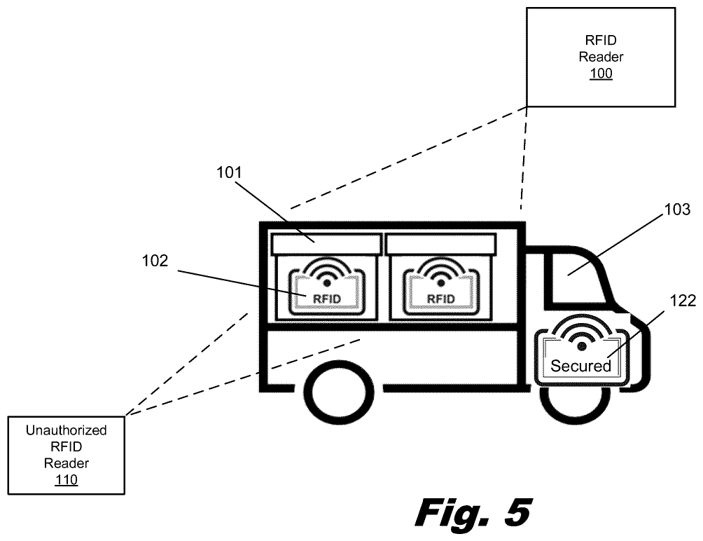

FIG. 5 illustrates another example of the principles described. As shown in FIG. 5, the units of cargo 101 may each have a regular RFID tag 102 associated or affixed. The transport vehicle 103 may have the secured RFID tag 122 affixed to it. In this example, the operator of the transport vehicle can, upon arrival at an authorized reader location, enable the secured RFID tag 122 to transmit data. For example, the secured RFID tag 122 could be in the operator's compartment of the transport vehicle 103 and readily accessible to an operator. The secured RFID tag 122 can then transmit its data to enable the authorized reader 100 to access the complete data sets associated with the cargo. For example, as described above, the secured RFID tag 122 may be storing the sensitive portions of the data sets or an encryption key needed to decrypt the data from the regular RFID tags 102.

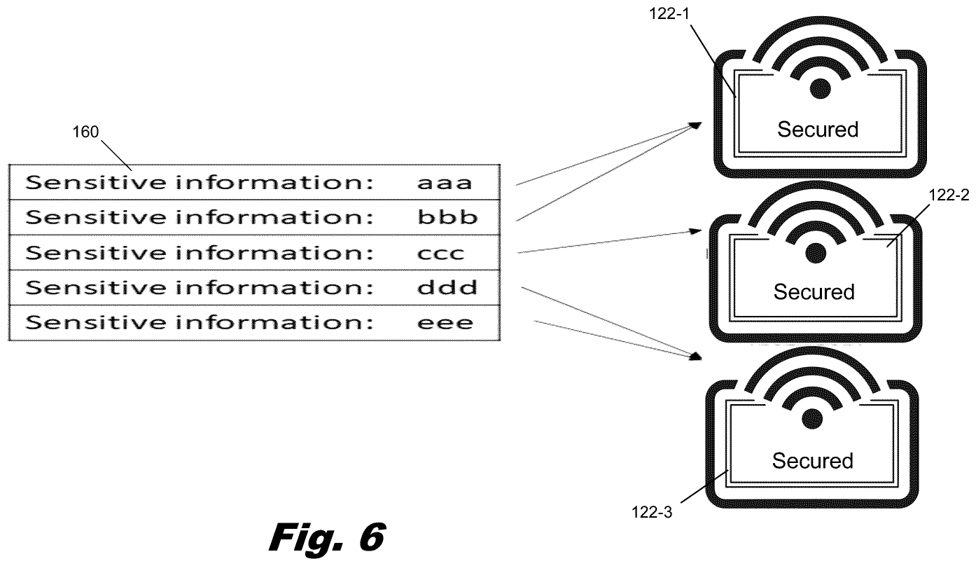

FIG. 6 illustrates another possible aspect of the technique described. As shown in FIG. 6, a data set 160 may have several fields of sensitive information. To better secure this sensitive information, the sensitive information is divided among multiple secured RFID tags 122. In the illustrated example, sensitive information aaa and bbb is stored in a first secured RFID tag 122-1. Additional sensitive information ccc is stored in a second secured RFID tag 122-2. Lastly, sensitive information ddd and eee is stored in a third secured RFID tag 122-3. In this way, if an unauthorized reader inadvertently gains access to the sensitive information in one of the secured RFID tags 122, the remaining sensitive information will remain secure. An unauthorized reader might inadvertently gain access to one of the secured RFID tags if, for example, a user inadvertently leaves one the secured RFID tags enabled to transmit when transmission should be disabled.

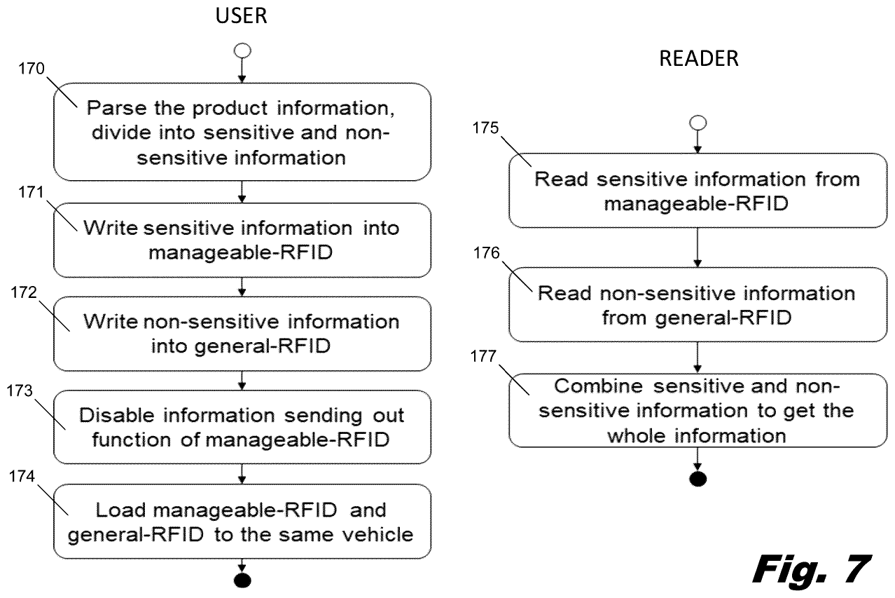

FIG. 7 is a flowchart illustrating an example of the technique described. In FIG. 7, actions taken by a user or operator are listed to the left. The operation of the RFID reader is detailed on the right.

As shown in FIG. 7, the user will first parse 170 the information, for example, the product specifications, to determine what is sensitive and non-sensitive information. Once, the sensitive and non-sensitive information is divided 170, the sensitive information is written 171 into a secured or “manageable” RFID device. The non-sensitive information is written 172 in to a regular or general RFID device. The transmitting capability of the secured/manageable RFID device is disabled 173. Then, in this example, both RFID devices are loaded 174 into a transport vehicle with cargo 174. While use of this technique has been illustrated in various examples associated with cargo shipping or inventory, as also described herein, the technique is applicable in many other contexts.

As also shown in FIG. 7, the operation of an RFID reader is as follows. The reader will read 175 the sensitive information from the secured or manageable RFID device. As described herein, this occurs only when the secured RFID device is enabled to transmit data. Various examples of selectively enabling and disabling transmission by the RFID device are described herein, but any mechanism for selectively enabling/disabling the transmission may be used. Next, the reader will read 176 the non-sensitive information from the general RFID devices. The reader can then combine 177 the sensitive and non-sensitive information to obtain the whole data set.

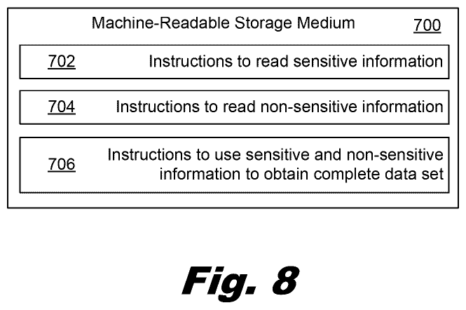

FIG. 8 illustrates a computer program product that includes a non-transitory machine-readable medium 700 for storing instructions for a radio frequency identification reader system. The instructions, when executed by a processor of the reader system alone or in combination with other processors, causes the reader system to: read sensitive information from a secured RFID tag when the RFID tag is enabled for data transmission, the secured RFID tag comprising a transmission control for selectively enabling and disabling data transmission from the secured RFID tag; read non-sensitive information from a separate, regular RFID tag; and use the sensitive and non-sensitive information to obtain a data set to which both the sensitive and non-sensitive information correspond. Consequently, FIG. 8 illustrates instructions to read the sensitive information 702; instructions to read the non-sensitive information 704 and instructions to use the sensitive and non-sensitive information to obtain the complete data set 706.

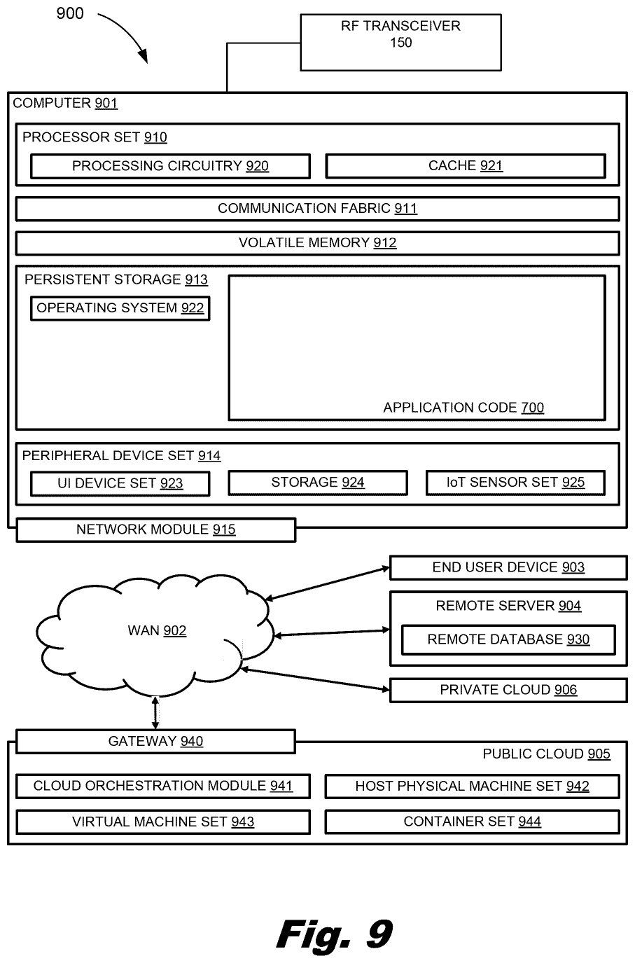

FIG. 9 depicts a computing environment 900 for the execution of unknown object sub-class identification, according to an example of the principles described herein. As shown in FIG. 9, a radio-frequency reader system may include a radio frequency (RF) transceiver 150 to communicate with an RFID tag, as described above. A processor, e.g., computer 901, uses the output of the transceiver 150 to process and obtain the data stored in the RFID tags described herein. The computing environment 900 can also be used to write data to an RFID tag.

The computing environment 900 contains an example of an environment for the execution of at least some of the computer code, e.g., the instructions of FIG. 8, involved in performing the inventive methods. In addition to code 700, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 700, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 1. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 700 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in block 700 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

The EUD 903 may be a client device operated by a producer of services or products that wants an analysis of available user data to ascertain user satisfaction. Operation of the EUD 903 for this objective will be described in further detail below.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

As described further below, the EUD 903 may use the network 902 to access an application on remote server 904. The application will access, again using the network 902, available user data. The application will then analyze the user data, with context specific analysis, to ascertain user satisfaction and generate recommendations for the producer based on the analysis.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

What is claimed is:

1. A secured radio frequency identification device comprising:
a first radio frequency identification (RFID) tag; and
a secured radio frequency identification (RFID) tag comprising a transmission control for selectively enabling and disabling data transmission from the secured RFID tag;
wherein the first RFID tag is to store non-sensitive data from a data set and the secured RFID tag is to store sensitive data from the same data set such that all the data of the data set is only accessible when the secured RFID tag is enabled for data transmission.

2. The device of claim 1, wherein the transmission control comprises a location aware circuit to determine a location of the device and to only enable data transmission of the secured RFID tag when the device is determined to be in an authorized location.

3. The device of claim 1, wherein the transmission control comprises a switch for selectively preventing data of the secured RFID tag from being transmitted by an antenna of the secured RFID tag.

4. The device of claim 1, further comprising multiple, first RFID tags, each to store non-sensitive data of a data set, the secured RFID tag to store sensitive data corresponding to the non-sensitive data in the multiple first RFID tags.

5. The device of claim 1, wherein the data set comprises data for a unit of cargo or inventory.

6. The device of claim 1, wherein the non-sensitive data in the first RFID tag is stored in an encrypted form and the sensitive data stored in the secured RFID tag is an encryption key for decrypting the non-sensitive data.

7. The device of claim 1, wherein the first RFID tag is affixed to a unit of cargo on a transport vehicle and the secured RFID tag is disposed in the same transport vehicle.

8. The device of claim 1, further comprising multiple secured RFID tags, wherein the sensitive data is further divided with only a portion of the sensitive data stored in each of the secured RFID tags.

9. A method of securing a data set in a radio frequency identification (RFID) device, wherein the RFID device comprises at least one regular RFID tag and at least one secured RFID tag, each secured RFID tag comprising a transmission control for selectively enabling and disabling data transmission from that secured RFID tag, the method comprising:
parsing a data set to divide the data set into sensitive and non-sensitive information;
writing the sensitive information of the data set to a secured RFID tag; and
writing the non-sensitive information of the data set to a regular RFID tag;
wherein the data set can be entirely accessed from the RFID device only when the transmission control has enabled data transmission in the secured RFID tag.

10. The method of claim 9, further comprising, when the transmission control has enabled data transmission in the secured RFID tag,
reading the sensitive information from the secured RFID tag;
reading the non-sensitive information from the regular RFID tag; and
combining the sensitive and non-sensitive information to obtain the data set.

11. The method of claim 9, wherein the transmission control comprises a location aware circuit to determine a location of the device, the method further comprising only enabling data transmission of the secured RFID tag when the device is determined to be in an authorized location.

12. The method of claim 9, wherein the transmission control comprises a switch for selectively preventing data of the secured RFID tag from being transmitted by an antenna of the secured RFID tag.

13. The method of claim 9, wherein the device comprises multiple, regular RFID tags, the method further comprising:
storing non-sensitive data of one or more data sets in respective regular RFID tags; and
storing sensitive data from the one or more data sets in a single secured RFID tag.

14. The method of claim 9, wherein the data set comprises data for a unit of cargo or inventory, and the method further comprises affixing a regular RFID tag to each unit of cargo or inventory.

15. The method of claim 9, further comprising:
encrypting the non-sensitive data for storage in a regular RFID tag in encrypted form; and
storing an encryption key for decrypting the non-sensitive data in a secured RFID tag.

16. The method of claim 9, further comprising;
affixing the one or more regular RFID tags to respective units of cargo on a transport vehicle; and
disposing the secured RFID tag in the same transport vehicle.

17. The method of claim 9, further comprising using multiple secured RFID tags, wherein the sensitive data is further divided with only a portion of the sensitive data stored in each of the secured RFID tags.

18. A computer programming product comprising a non-transitory machine-readable medium storing instructions for a radio frequency identification reader system, the instructions, when executed by a processor of the reader system, causing the reader system to:
read sensitive information from a secured RFID tag when the RFID tag is enabled for data transmission, the secured RFID tag comprising a transmission control for selectively enabling and disabling data transmission from the secured RFID tag;
read non-sensitive information from a separate, regular RFID tag; and
use the sensitive and non-sensitive information to obtain a data set to which both the sensitive and non-sensitive information correspond.

19. The product of claim 18, wherein the non-sensitive information is in encrypted form and the sensitive information comprises a key for decrypting the non-sensitive information, the instructions further causing the processor, decrypting the non-sensitive information with the key.

20. The product of claim 18, wherein the instructions further cause the processor to combine the sensitive and non-sensitive information to obtain the data set, both the sensitive and non-sensitive information being parts of the data set.
